(19) United States
(12) Patent Application Publication
(10) Pub. No.: US 2026/0065189 A1
(43) Pub. Date: Mar. 5, 2026

(54) DEMAND MANAGEMENT OF MATERIAL REQUIREMENTS PLANNING

(71) Applicant: BLUE ORIGIN MANUFACTURING, LLC, HUNTSVILLE, AL (US)

(72) Inventors: William Cha, Merritt Island, FL (US); Sean Ujiye, Los Alamitos, CA (US); Sean O'Connor, San Francisco, CA (US); Juan Hernandez, Winter Springs, FL (US); Sealand Gowyn, Viera, FL (US)

(21) Appl. No.: 18/824,360

(22) Filed: Sep. 4, 2024

(51) Int. Cl. G06Q 10/0631; G06Q 10/0875

(52) U.S. Cl. CPC G06Q 10/06315; G06Q 10/0875

(57) ABSTRACT

Systems and methods are directed toward managing demand, such as for manufacturing in complex supply and/or demand driven environments, including aerospace-industry products and systems, environments with a multitude of stakeholders, and other sophisticated organizations. A production request may be provided with a component identifier for a top-level module component to be produced. Data associated with the component identifier may be determined. The data may include one or more additional component identifiers for sub-components which are to be consumed to produce the top-level module component. Supply allocations for the top-level module component and the sub-components may be generated based at least in part on the data. One or more action signals may be provided to fulfill the production request for the top-level module component according to the supply allocations.

### TECHNICAL FIELD

Developments herein relate generally to material requirements planning having features to manage demand from top-level module part numbers.

### BACKGROUND

A material requirements planning (MRP) system typically includes software with an integrated inventory and supply management system to estimate required quantities of materials, maintain inventory, and schedule production. The MRP system can calculate which materials to make and which materials to source based on various inputs to support production planning and supply chain scheduling, including bill of materials (BOM), item masters, demand, on-hand inventory, and incoming receipts. Demand management typically balances supply and demand to ensure production needs are met while also allowing revenue to be generated, where supply, demand, production needs, revenue, and other relevant factors are considered as part of complex environments. Demand management can forecast demand, set pricing strategies, and ensure inventory is available when required, including for complex supply and/or demand driven environments, such as those for building rockets and/or space-industry relevant parts, products, and systems.

### SUMMARY

In one example, a system herein includes at least one processor and memory having instructions which when executed by the at least one processor cause the system to perform functions to fulfill production requests. The functions include receive a production request comprising a component identifier for a top-level module component to be produced. A further function caused in the system is to determine data associated with the component identifier. The data may comprise one or more additional component identifiers for sub-components to be consumed to produce the top-level module component. A further function of the system is to generate, based at least in part on the data, supply allocations for the top-level module component and the sub-components. A further function of the system is to provide one or more action signals to fulfill the production request for the top-level component according to the supply allocations.

In another example, one or more circuits herein are to provide one or more actions signals to fulfill a request for a top-level component according to supply applications for the top-level component and one or more sub-components. The supply allocations generated using an identifier for the top-level component to determine the one or more sub-components.

In yet another example, a method herein is for fulfilling production requests. The method includes receiving a request comprising an identifier for a top-level component. The method includes determining data associated with the identifier. The data may comprise one or more additional identifiers for sub-components to be consumed to fulfill the request. The method further includes generating, based at least in part on the data, supply allocations for the top-level component and the sub-components. The method further includes providing one or more action signals to fulfill the request for the top-level component according to the supply allocations.

### BRIEF DESCRIPTION OF DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise.

FIG. 1 illustrates an environment for a demand management system for material requirements planning, according to at least one embodiment;

FIGS. 2A and 2B illustrate features of production instructions for a demand management system, according to at least one embodiment;

FIG. 3 illustrates features of a demand graph for a demand management system, according to at least one embodiment;

FIG. 4 illustrates further features of a demand graph for a demand management system, according to at least one embodiment;

FIG. 5 illustrates computing features of an environment for a demand management system for material requirements planning, according to at least one embodiment;

FIG. 6 illustrates further computing features of an environment for a demand management system for material requirements planning, according to at least one embodiment; and

FIG. 7 illustrates a process flow for a demand management system for material requirements planning, according to at least one embodiment.

### DETAILED DESCRIPTION

As used herein, a bill of materials (BOM) may be a list of materials needed to construct a given part, such as a top-level module component. The BOM may be an engineering BOM (eBOM) or a manufacturing BOM (mBOM). The eBOM may be created during the design phase, while the mBOM may be created for the manufacturing phase. The materials detailed in the BOM may be requested from a supplier, such as purchased with a purchase order (PO), or may be requested to be built inhouse. As used herein, the PO may be an order to a supplier for a given part or parts. As used herein, a part required by the demand of a system and/or provided by the supply of a system may be a component, product, element, or other resource. The part may be utilized by the system, such as in manufacturing, consuming, using, building, sourcing, referencing, and providing.

As used herein, a work order (WO) may include a set of instructions or guidelines for producing a given part or procedure, as well as a record, such as a mBOM, of sub-parts consumed to produce the given part. The WO may be a template work order (tWO), an electronic work order (eWO), or other suitable formats. The tWO may include a set of instructions which can be reused to complete requests in the future. The tWO may include a list of operations in a sequence, such as a directed acyclic graph. There may be different types of the tWO, such as a produce/consume (P/C) tWO, a procedure tWO, a non-conformance (NC) tWO, and a maintenance tWO. The P/C tWO may include instructions to consume parts listed on a BOM to produce a specific set of parts. The procedure tWO may include instructions to complete a procedure without producing a part, and may not include instructions to consume parts. The NC tWO may include one or more parts and operations to fix an error in the manufacturing of one or more specific instances of a part. The maintenance tWO may include instructions to perform repairs to one or more specific instances of a part. The eWO may be a record of a completed set of operations or instructions and the specific materials consumed. For example, the eWO may record a material moved from inventory to a staging area. Additionally, the eWO may record pictures and notes for a given operation or instruction. The tWO and the associated operations may be used to create one or more eWOs. Alternatively, an eWO may not be created without a tWO, or may have differences from the parent tWO, such as if alternative production instructions were completed.

As used herein, a manufacturing plan (MP) may be a template of instructions or guidelines to produce one or more parts by connecting activities for a request of a given part or procedure. The MP may also include details of any sub-parts required to produce a top-level module part, such as a BOM, and the MP may be associated with one or more parts related to those activities. As used herein, an activity may include instructions, or plans, to be completed when the activity is started. The activities may be associated with one or more parts, the corresponding part numbers, one or more WO, and materials lists. The part number may be a reference numbers, a component identifier, an identification number, a non-numeric identifier, or other suitable information used to identify a part or element. The activities may be connected, such as in a directed acyclic graph. The activities may include instructions to run other MPs before any successor activities can be started. An activity may include one or more eWO, tWO, part numbers, and other relevant information. A tWO included in an activity may be replaced by a eWO to record completed actions performed at that activity. The actions may be used to track processes involving one or more different WO, even when there is no complete part structure. As used herein, a manufacturing plan execution (MPX) may be a specific instantiation of one or more activities and may be associated with one or more parts related to those activities. A MP may include one or more MPX, and a MPX may be created without a MP.

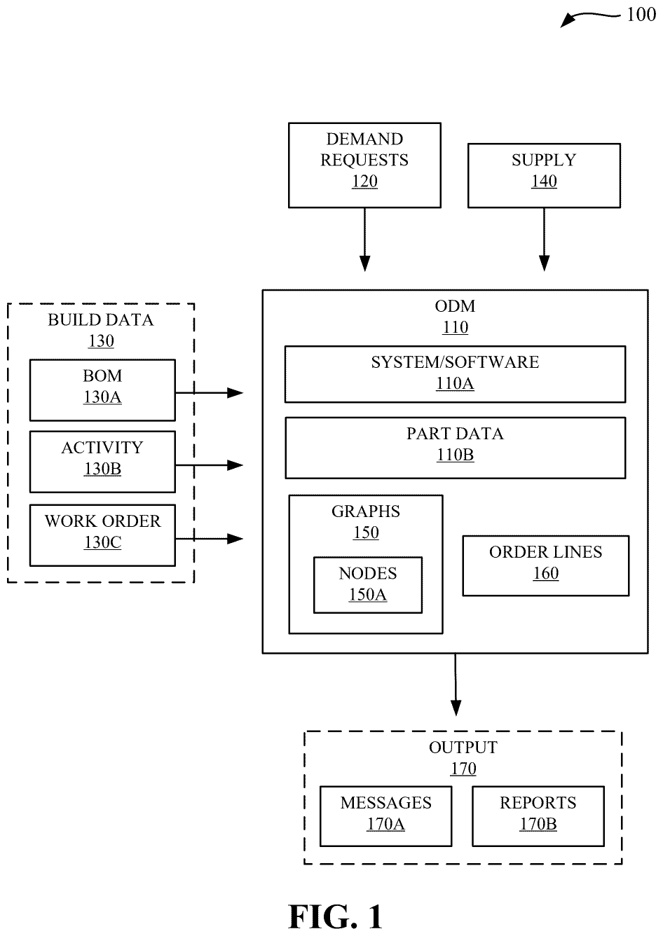

FIG. 1 illustrates an environment 100 for a demand management system 110 for material requirements planning, according to at least one embodiment. The demand management system 110, such as an order demand management (ODM) system, may operate as a workflow using one or more systems or software 110A to update demand to be fulfilled within a system, including where supply, demand, production needs, revenue, and other relevant factors are considered as part of complex environments. The workflow may update the demand for each production request or demand request 120 received as an input to the ODM 110. The request 120 may include the demand from part data 110B, or information, for one or more parts associated with the request 120. The ODM 110 may drive demand, or fulfill a request 120, from the top-level module part numbers using an automated material requirements planning (MRP). Driving or generating demand may include gathering all of the demand for materials needed to fulfill a request 120. The ODM 110 may not be limited to environments for the production of parts or products, but may be also utilized in other environments which rely on supply and demand, such a financial transactions, workforce labor, and computing instances. The ODM 110 may be used to manage demand within the complexity of planning, organizing, building, manufacturing, and fulfilling orders, such as rockets and aerospace-industry relevant parts and systems, in multifaceted supply and/or demand driven environment with a multitude of stakeholders and other considerations. In an example, the ODM 110 may manage demand for the production of multiple types of rockets including different rocket engines, sub-parts, peripheral parts, tooling, and other requests, coordinating numerous internal and external individuals, groups, and systems. One or more systems or processes described herein, including the ODM 110, may be automated or partially automated.

The request 120 may include one or more top-level module part numbers associated with respective top-level parts, where the top-level module parts are the final products to be produced or created according to the request 120. The part data 110B may include information related to the top-level or parent parts as well as the dependent or child parts and sub-assemblies related to the top-level parts. The part data 110B may be provided to the ODM 110 as any suitable information and may be input, referenced, or stored as needed. For example, the part data 110B may be provided as build data 130 which includes information to build child parts or parent parts, such as a BOM 130A, an activity 130B, or a WO 130C. The BOMs 130A, the activities 130B, and the WOs 130C may be provided to the ODM 110 and stored in the related information 110B. In some cases, the request 120 may include new part data 110B and/or build data 130 relevant to the top-level module parts of the request 120. The ODM 110 workflow may also update demand for child parts, required to produce requested top-level parts, based on the part information 110B included in the BOMs 130A, the activities 130B, and the WOs 130C. The ODM 110 may then match or allocate all demand with a known supply 140, where the supply information 140 is received from one or more supply sources. The ODM 110 may then generate output 170, such as action messages 170A and reports 170B, based on one or more of the demand 120, the supply 140, the related information 110B, and other information. The output 170 may be provided, made available, or sent to users. The outputs 170 may also include alerts or signals to indicate that information should be reviewed or that actions should be taken, such as according to the supply allocations. For example, a request 120 may be received that includes a top-level module part numbers associated with a sophisticated and investment-heavy product, within a complex and multi-level environment, such as a rocket engine. The part data 110B related to the rocket engine may include information related to the rocket engine as well as sub-assemblies, processes, and subprocesses related to the rocket engine. Information related to the rocket engine may be provided to the ODM 110 may be retrieved by the ODM 110 from any suitable source, and may be provided, at least in part, with the request, such as an update or customization. The ODM 110 may then allocate the required demand for the rocket engine with the known supply 140, which may include up to or more than hundreds or thousands of parts and processes. The ODM 110 may then send notification or perform action to fulfil the request by coordinating the completion of the rocket engine, such as by involving up to or more than ten or hundreds of entities. In another example, the request 120 may be for any relevant demand, including highly complex products or processes as well as part of extensive organizations or groups.

The ODM 110 may generate MAKE and BUY messages 170A which indicate one or more parts in demand require additional supply 140 by either making or buying the parts. First, for each top-level module part of each request 120 an estimated end-by-date may be determined, as well as any child parts, based on the latest estimated end-by-date of any of the child parts and the latest estimated end-by-date of the supply matched to the parts and the child parts. Each material demand can be checked to determine whether sufficient supply 140 has been matched. If sufficient supply 140 has been matched, all child parts can be ignored. For each material demand without sufficient matched supply, a MAKE or BUY message 170A can be generated. The MAKE and BUY messages 170A may include any relevant information to provide sufficient directions, such as the current estimated start date, the current estimated completion date, the original start date, the original completion, the dates of the first and last operations to produce or purchase the material demand, and the make code and the buy code to identify the source for the part. The MAKE and BUY messages 170A may be aggregated, such as by part number, part version, inventory abbreviation, cost-code, and/or the estimated start date. For example, a first demand for two units and a second demand for three units on the same day with the same project code may be combined into one message 170A for five widgets. For the supply 140 which is currently in inventory, the MAKE and BUY messages 170A may be automatically generated to reorder parts if the total inventory for the part is less than a required demand amount. If parts are determined not to be needed, the messages 170A may be generated to cancel MAKE and BUY messages 170A, or portions of MAKE and BUY messages 170A. The ODM 110 may generate other messages 170A as needed based on the requirements of fill demand, such a messages 170A to expedite or de-expedite MAKE and BUY messages, or parts of MAKE and BUY messages 170A. The information may also be included in the reports 170B or other outputs 170.

The messages 170A may include several date fields, such as action required by date, deferred start date, deferred end date, need by date, expected duration, start date delay, and end date delay. The action required by date may be the estimated end-by-date when an action can be started. The deferred start date may be the same as the action required by date unless a deferral has been added. The deferred start date may be referenced in a planner report 170B for BUY parts or in a buyer report 170B for MAKE parts. The deferred end date may be determined from the action required by date plus the duration identified during the demand gathering. The deferred end date may be referenced in a planner report 170B for BUY parts or in a buyer report 170B for MAKE parts. The need by date may be the earliest need by date derived from the original request date identified during the demand gathering from all of the aggregated messages 170A. The expected duration may be the associated duration identified during the demand gathering from all of the aggregated messages 170A. The start date delay may be the difference between the earliest start by date from the original request date of the aggregated messages 170A and the estimated start by date, with a minimum of zero. The start date delay may be referenced in a planner report 170B for BUY parts or in a buyer report 170B for MAKE parts. The end date delay may be the difference between the earliest end by date from the original request date of the aggregated messages 170A and the estimated end by date, with a minimum of zero. The end date delay may be referenced in a planner report 170B for BUY parts or in a buyer report 170B for MAKE parts. Any of the dates may be a single date, a range of date, a specific time, other suitable time reference.

The ODM 110 may generate and provide reports 170B, such as a supply and demand report, forecast report, a planner message report, and a buy message report. The ODM 110 may generate the supply and demand report 170B which may include all of the related supply 140 and demand information for individual parts. For example, the supply and demand report 170B may show the total number of a part in inventory, the total number of parts which have been ordered, and all the demand in the system that require parts to be allocated. The ODM 110 may also provide the forecast reports 170B based at least in part on the demand in the system. For example, the forecast report 170B may indicate when inventory for a part is forecasted to be depleted. The forecast report 170B may be generated and sent for requests 120 which cannot be completed based on the forecasted lack of inventory. The planner message report 170B may include information related to one or more parts which need to be built inhouse and may be used to generate the build signals. The buy message report 170B may include information related to one or more parts which need to be sourced and may be used to generate the buy signals. The ODM 110 may generate and send messages 170A which indicates more supply 140 should is needed because the inventory is forecasted to be depleted. The messages 170A may also recommend certain actions, such as opening a purchase requisition to obtain additional inventory by the date the part is needed for a request. The messages 170A may be generated to provide details of all the parts which the ODM 110 has determined will lack supply to fulfill the demand. Based on the messages 170A, build orders or purchase requisitions may be released to ensure sufficient supply is available, using build signals and buy signals, respectively. The required actions provided in the messages 170A may be completed manually or automatically. The ODM 110 may also generate and send output 170 with information regarding the statuses of order lines 160, how products are to be manufactured, and a shortage report disclosing the causes of supply shortages. The output 170 from the ODM 110 may be provided numerous recipients, such as people or groups, including those as part of a larger entity. The people, groups, entity, and those outside of the recipients, which may include up to or more than hundreds of individuals and systems can coordinate to fulfil the request, and a multitude of other requests of various complexity and diversity, based in part on the provided output.

A request 120 including related information may be submitted to the ODM 110 for a top-level module part, more than one of the same part, or multiple parts. The information included in the request 120 input to the ODM 110 may only include a limited amount of information, such as the top-level part numbers, the requested quantities, and a requested completion date for the request 120. The ODM 110 may then determine information related to the demand created by the request 120, which may be output 170 to a user, such as on a display. The determined information may include order lines 160 associated with the parts required to complete the request 120. The order lines 160 may include line item details for the parts which will be consumed to fulfill the request 120. For example, a request 120 may include information relating to an aerospace rocket component to be manufactured, such as multiple fuel tank assemblies. The request 120 may include information including reference numbers for the fuel tank assemblies, the number of assemblies to be manufactured, and a desired completion date. Information determined by the ODM 110 related to the request may be generated or retrieved and displayed to a user. The displayed information, such as orderliness related to the request, may include the parts, tools, assemblies, and processes required to complete the fuel tank assemblies, the number of each part required, the number of available parts as well as the number unavailable parts, the part sources, the amount of time needed to source each part, and other relevant information. The parts or activities may include individual parts, such as washers, nuts, and bolts, sub-assemblies such as heat shield arrays, connections assemblies, and interior walls, and actions such as assembling, cutting, attaching, finishing, and shipping. The ODM 110 may use the order lines 160 of all active requests to retrieve all of the demand in the system. The ODM 110 may retrieve all the current supply 140, and then generate one or more other outputs 170 based on the supply 140 and demand, and other relevant information. The ODM 110 can determine all demand in the system by referencing all of the order lines 160 for all the current requests 120. While the demand quantities for top-level module parts are provided by the requests 120, the ODM 110 can determine the remaining demand information by cascading related the order lines 160. The order lines 160 may be generated or referenced, such as from the build data 130 and/or the part data 110B. The requested completion dates, supply quantities, and availability associated dates with the order lines 160 may be used to determine the allocated supply 140. Additionally, missed deadlines and forecasted completion dates can be determined and used to generate outputs 170. The dates may be calculated by the ODM 110 based at least in part on one or more of the supply 140, the demand, and the determined allocation data, which may be maintained in the order lines 160.

A submitted request 120 may be stored by the ODM 110 and used to reference for generating the outputs 170. The request 120 may be linked, or associated, with one or more of the build data 130, such a MP, a MPX, a mBOM, a tWO, an eWO, or other suitable information, based on the part numbers included in the request 120. The part information 110B related to the request 120 may be referenced by the ODM 110 to determine demand and generate the messages 170A. The request 120 may also include an intended completion date, a quantity of the one or more parts requested, associated part numbers, a cost code mapping, and other relevant information. Further, the ODM 110 may process activities 130B associated with a request 120 differently than the BOMs 130A and the WOs 130C when determining demand and generating messages 170A. The ODM 110 may also receive a request 120 which generates demand that is not associated with an activity 130B. For example, a request 120 may be associated with the WO 130C which is not listed on the activity 130B. In another example, a related PO may be used to create a single activity 130B for a part not otherwise provided for in the related production instructions. Additional instructions may be added to the single activity 130B for the PO, such as if needed to complete the request 120. The build data 130 and the part data 110B may be updated, such as based on changes to production specifications and customer specifications. The ODM 110 may use the most up to date build data 130 and part data, or may be able to select from among multiple versions of available date build data 130 and part data.

The ODM 110 may a create one or more demand graphs 150 for the requests 120, such as an acyclic graph, formatted line item detail information, or other suitable structure. A demand graph 150 may link each instance of demand for parts included in a request 120 to the sub-assemblies of the respective parts. A demand graph 150 may include one or more activity 130B demands as demand graph nodes 150A or objects. The demand graph nodes 150A may include material information, such as BOM 130A lines, material demand tree nodes (MDTNs), or other suitable information. The line items, such as those included in the BOMs 130A, may be represented in the demand graphs 150 by objects 150A, such as MDTNs, material demands, or dependencies. The objects 150A used to represent activities 130B may be different from the objects 150A used to represent line items, although the different objects 150A may share one or more properties. The ODM 110 may store and/or reference the demand graphs 150 to determine information related to the current demand and may provide the demand graphs 150 to users. The ODM 110 may be able to identify child parts which are not consumed based on the build data 130, part data 110B, demand graphs 150, or other information, and may provide related messages 170A or reports 170B.

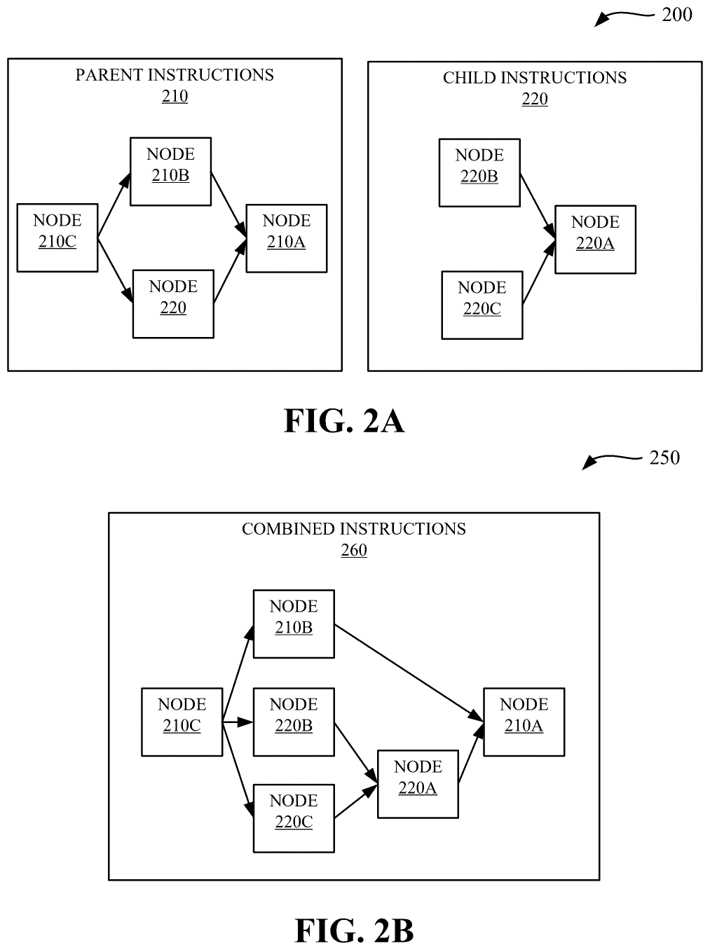

FIGS. 2A and 2B illustrate features 200, 250 of production instructions 210, 220, 260 for a demand management system, according to at least one embodiment. A request may be submitted which is associated with production instructions 210, such as the parts data or the build data, to complete the request. The request may be received within a large scale, complex organization or system, where myriad of components or processes are able to be completed. The one or more production instructions 210, 220, 260 may be referenced or generated for the request based in part on the request and/or provided with the request. To create the production instructions 210, 220 260 for the request, the ODM may analyze each of the included instructions and related information to the parent parts and the child parts. The parent instructions 210 may be created by analyzing the top-level parts data and the top-level build data to determine the top-level line items which are used to determine the parent nodes 210A, 210B, 210C, 220, or the parent material demands. The child instructions 220 may be created by inspecting and filtering related data for line items which have not been referenced in other instruction which are then used to determine the child nodes 220A, 220B, 220C, or the child material demands. If the instructions 210, 220 260 are already built, such as if activities which include instructions 210, 220 260 are referenced for one or more parts, the instructions 210, 220 260 may be used from those templates. In yet another example, if an eWO is present and completed, the ODM may indicate the statuses related to the instructions 210, 220 260 have been completed. The parent instructions 210 and the child instructions 220 determined by the ODM may then be combined to create a single combined instructions 260 for the top-level part.

In an example, a request for top-level parts may be associated with sub-instruction, including parent instructions 210 for the top-level part, and child instructions 220 for the parts required to be consumed for the completion of the top-level part. The child instructions 220 may also include one or more intermediate instructions between another child instruction 220 and the parent instruction 210, which may be lower or higher, such as in hierarchical levels. For example, a parent instruction 210 may be higher than any child instruction 220. The higher instruction 210 may be created by the ODM based on the respective higher-level part and the lower instruction 220 may be created by the ODM based on the respective lower-level part. The higher instruction 210 and the lower instruction 220 may be combined into a larger instruction 260 based on both of the related sub-instructions 210, 220.

For example, a node 220 of the parent instructions 210 may call out the child instructions 220. Therefore, the part produced by the child instructions 220 would be consumed as the node 220 by a node 210A. As indicated with the arrows, time, or progress for the instructions 210, 220, 260 moves left to right and each arrow points from predecessor to successor. Therefore, the node 210A is the terminal node, or last node to be completed, of the parent instructions 210 and the combined instructions 260. Additionally, a node 210C is consumed by a node 210B which is consumed along with the node 220 by the terminal node 210A of the parent instructions 210 and the combined instructions 260. As shown in the combined instructions 260, the node 210C is also consumed by a node 220B and a node 220C, which are also included in the child instructions 220. Then, the node 220B and the node 220C may be consumed by node 220A of the child instructions 220 and the combined instructions 260. The ODM may detect when an instruction 210, 220, 260 refers to itself, in which case the instruction 210, 220, 260 may be aborted in case the self-reference would create an infinite production instruction.

In an example, a production instruction may be generated or referenced for a request submitted to the ODM which is associated with information to complete the request, such as an activity. For each of the activities, the ODM may also maintain other information, such as the produced parts, the list of parts which each activity creates, and current supply levels. Some of the information may be referenced from the activities eWO field, the tWO field, or the part numbers manually entered for that activity. In another example, production instruction may be generated for a request which is not associated with any instructions to complete the request, such as a mBOM. The request may be processed to generate the instructions as if there was one activity which linked to the information associated with the request, such as a WO or mBOM, and then cascades down the linked mBOM. If the mBOM terminates at one part, but there is a default mBOM for the part, the mBOM may be expanded by attaching the mBOM for the terminal part to the terminal part in the parent mBOM. In yet another example, the production instruction may be generated for a request submitted to the ODM which is not associated with an activity to complete the request, such as an eWO. A non-ordered eWO may be processed as a tWO, where the ODM indicates the statuses of all completed parts under the eWO related to the instructions have been completed. The instructions or templates may be used as a historic procedural template or record of a part or component, detailing how the product was built. Multiple versions of the instructions or templates may be available. The instructions or templates may be provided or referenced for disassembly, maintenance, or refurbish activities and operations of a produced part.

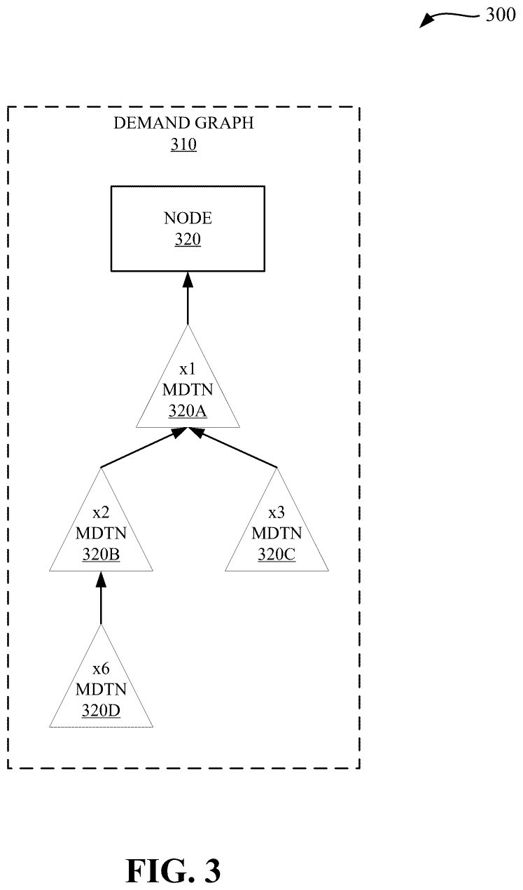

FIG. 3 illustrates features 300 of a demand graph 310 for a demand management system, according to at least one embodiment. A demand graph 310 generated by the ODM from a BOM may have one or more demand graph nodes 320. The nodes 320 may have material demand trees compassed of material demands or MDTNs 330, 340, 350, 360, which each correspond to a line item detail, such as BOM or mBOM lines. For a particular part, the default part plan or build data may be referenced based on the part identification, such as a part number, to retrieve the default plan BOM or line item details. The ODM may then recursively repeat the process for each node 320 before translating all of the default plans into a material demand graph 310. The default plan BOM may be selected by any suitable method. In an example, a default plan may be selected for a request for a part associated with an ordered WO. The BOM line item details may be referenced based on information included in the WO. The BOM for the part, Part A, may include line items as in Table 1.

TABLE 1

| Part | Quantity |
|---|---|
| A | 1 |
| B | 2 |
| C | 3 |

Therefore, the production of the Part A, may require two of a Part B and three of a Part C. The Part C may require no other parts to be produced, while the Part B may require additional parts. The ODM may then reference and select a default plan for Part B. The BOM for the Part B may include line items as in Table 2.

TABLE 2

| Part | Quantity |
|---|---|
| B | 1 |
| D | 3 |

Therefore, the production of the Part B, may require three of a Part D. The ODM may cascade the information by attaching the BOM line item details for the Part B under the BOM for the Part A and then multiplying out the required part quantities. The ODM may then create the demand graph node 320, where a MDTN 320A represents one of the Part A, a MDTN 320C represents the three of Part C, a MDTN 320B represents two of the Part B, and a MDTN 320D represents six of the Part D. The part dependency of the demand graph node 320 may be read as flowing down. For example, the demand graph node 320 is complete when the top-level produced part MDTN 320A, or root MDTN, is complete. A root MDTN and the associated demand graph have the same produced part. Similarly, the MDTN 320A is complete after the MDTN 320C and the MDTN 320B are complete, and the MDTN 320B is complete when the MDTN 320D is complete. A MDTN with no children, such as the MDTN 320C and the MDTN 320D, may also be known as leaf MDTN. A demand graph node 320 may always have one root MDTN, even if no default plan is found. Similarly, a non-ordered eWO, may be processed by storing the completion information on the associated BOM for each corresponding MDTN.

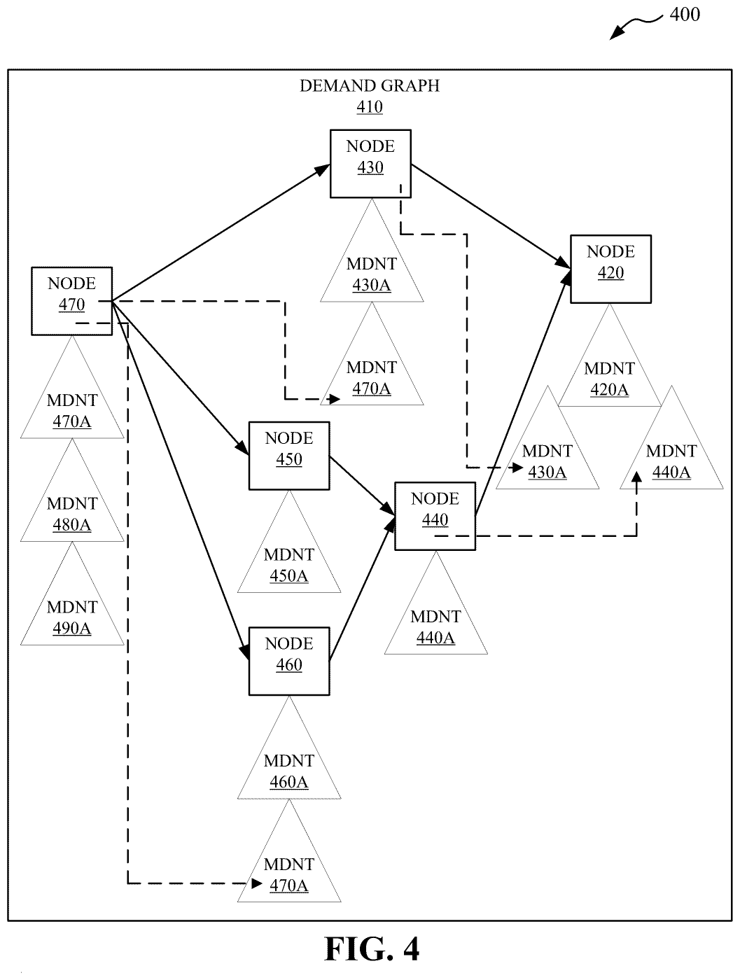

FIG. 4 illustrates features 400 of a demand graph 410 for a demand management system, according to at least one embodiment. A demand graph 410 may be generated for a request for one or more parts associated with one or more activities. The demand graph 410 may represent each activity as one or more nodes 420, 430, 440, 450, 460, 470 on the cascaded demand graph 410 in order to identify the required subassembly parts. The ODM may cascade the activity information associated with the related part numbers by referencing information in the activity and other information known about the parts. A fully cascaded set of instruction may be used to generate the demand graph 410, including the one or more nodes 420, 430, 440, 450, 460, 470 and one or more related MDTN 420A, 430A, 440A, 450A, 460A, 470A, 480A, 490A. As indicated with the solid arrows, time, or progress for the demand graph 410 moves left to right. Specifically, each solid line arrow points directly from predecessor to successor where the predecessor will be consumed. Similarly, each dashed line arrow points from predecessor the location of the predecessor will be consumed by an object or MDTN before being consumed by the successor.

A node, such as a demand graph node or MDTN may be used to store details, or information about the associated line items and activities. The details may include information related to the parts, such as MAKE/BUY information, completion duration, and pedigree information. The MAKE/BUY information may indicate whether the part is a MAKE part or a BUY part from the supply sources. A part indicated as MAKE may be built, such as being manufactured inhouse, while a part indicated as BUY may be sourced, such as being bought from an external entity. A part may also be indicated as both MAKE and BUY depending on which instructions are used with a request. One or more completion durations may be referenced by the ODM for the parts and assigned to the related node. The durations may be sourced from the duration estimates recorded the associated instructions, such as the MP or MPX for activities, from the values stored for parts, such as an item master in a BOM, or any other suitable source. The base value for a duration may be sourced from a completed activity such as an eWO, an uncompleted activity such as a tWO, an activity manual estimate in an instruction, such as an MPX, an item master estimated production lead time such as an MBOM line item, a default value, or any other suitable source. Post-processing lead time referenced from the item master may also be included. In some examples, since a graph node may have the same produced part as the root MDTN part, when the duration is already recorded in the parent graph node, the root MDTN may have a duration of zero. The pedigree information, or planUrn, identifies the activity source of the MDTN. For an activity, the planUrn for the top-level demand node 420 may also be the urn for the activity. For a node with a default plan, the planUrn may also be the urn for the default plan tWO or mBOM. Leaf nodes may have no planUrn because the relevant planUrn, and the associated planUrn may come from the parent MDTN planUrn.

In an example, a request associated with a tWO may be submitted to the ODM, and one or more BOM line item details may be referenced based on information included in the WO. The BOM for the part, Part A, may include line items as in Table 3.

TABLE 3

| | | MAKE/ | Duration | Duration | |
|---|---|---|---|---|---|
| Part | Quantity | BUY | (Days) | Source | PlanUrn |
| A | 1 | MAKE | 0 | root | root tWO |
| B | 2 | MAKE | 9 | Item Master | B default |
| | | | | | plan |
| C | 2 | BUY | 84 | BUY default | |
| D | 6 | MAKE | 28 | MAKE default | |

Therefore, the ODM may be able to reference the required information, such as the information in Table 3, from the related build data and part data associated with a request based on the provided top-level part number. The information can then be stored in the nodes or MDTN of a demand graph.

An intended completion date or need-by-date, for the terminal node 420 of the demand graph 410 associated with a request may be calculated based on the request need-by-date. The request need-by-date may be determined by the ODM and then assigned to the node to be completed last, or the terminal node 420. Since an activity can have multiple parents, each subsequent activity is assigned the earliest need-by-date of any parent activity, and the nodes are assigned accordingly. For example, node 470 would have the earliest need-by-date of node 430, node 440, and node 460. For example, a demand graph generated for request with a need-by-date may have a terminal node 420 with the same need-by-date. The need-by-date for the node 430 and the node 440 may be the need-by-date of node 420 less the node 420 duration, and so on. In another example, the need-by-date of node 470 which has the node 430, the node 450, and the node 460, may be the earliest need-by-date of the parent nodes less the parent duration. Each dependency or MDTN of a node may have one parent node, either from the mBOM or the activity linked to the mBOM. Therefore, the dependency or MDTN may have the same intended completion date as the parent node. For example, the MDTN 420A may have the same completion date as the node 420, and the MDTN 470A, the MDTN 480A, and the MDTN 490A may have the same completion date as the node 470.

After assigning need-by-dates, the ODM may match or allocate demand to supply in order to predict or forecast when materials will be needed for requests. The ODM may determine the forecast based on the immediately best match at each iteration of the determination, which may always choose the short-term gains. The ODM may determine the forecast based on any other suitable method or system. To determine the best gain on each iteration, the ODM may determine all of the demand and all the supply for any part found in demand. The determinations may be made based on the part numbers and may be determined while ignoring the different supply sources for a given part. The supply may include one or more of on-hand inventory, submitted purchase orders, submitted WOs, and all produced parts on activities. Each request may be collected, such as listed, and sorted by earliest to latest need-by date. The supply may then be scheduled to be provided to the requests based the need-by-dates, providing the supply first to the earliest need-by-date requests, and scheduling the supply for each of the later subsequent requests. Therefore, the requests expected to finish the soonest will receive as much supply as possible. The WOs not included on activities and/or not associated with need-by-dates may be added to the end of the list, sorted by creation date.

The supply may be matched or allocated to the demand in each of the requests by determining the root material demand, starting with the first sorted request. The root material demand may indicate the same part which the activity produces for each part associated with the requests. For each piece of demand in the sorted order of requests, each node, activity, or WO with no predecessors may be analyzed to determining the root material demand. For example, the outstanding root material demand included in the line items or the MDTNs of a request may be determined and matched to any available inventory. If sufficient supply is not available to fulfill the root material demand, then the supply is matched instead to the associated children and continue the process by repeating as necessary. For example, the ODM may match three units of supply with a material demand for three units, and the children material demands of the units may be ignored. The ODM may assign supply from one or more of the available sources and from the sources in any suitable order. For example, the ODM may first assign supply from inventory, then POs in the order of their expected arrival, then eWOs not listed on activities in the order of their creation. In another example, if the ODM must match a WO not associated with an activity, then the process of matching the supply to the demand may be repeated until the WO is fully matched and continue matching as described.

For each matched instruction, such as an activity or a WO, the ODM may analyze the dates when supply is to be provided for a demand and determine the latest date of supply. If the demand for the instruction is not fully supplied, the ODM may the remaining material demands and analyze the lead times and determine the dates when those parts could arrive if bought and/or planned at and earlier date of as soon as possible. The ODM may then determine the maximum date the needed supply would be available to then assign the maximum date as the estimated date for matched and unmatched material demands to be completed. After the estimated date for the completion of the request instructions is determined, the parts may be added to the available supply. The matching process may be repeated for all activities of the request in the topological order, beginning with all nodes with no predecessors, until all the request instructions have been processed. For example, referring again to FIG. 4, the ODM may first assign all the supply to the material demands of the node 470, then assign supply to the node 430, the node 450, and the node 460 since the order may not be defined for activities at the same level, then the node 440, and then the node 420. Therefore, if any predecessor activity produces a part demanded in the current activity, the part should be available in the ODM computed supply. The process of determining the root material demand to match the supply and demand may be repeated for each of the remaining requests which have been sorted.

After matching the supply and demand, the related dates and deadlines can be generated. The ODM may generate the messages and the reports based on the supply, the demand, the dates and deadlines, and other suitable information. The messages may include information related to the request, the instructions, and/or the parts, and may also include directions for performing one or more actions. The messages can include one or more actions which may be sent or provided to a user to perform the action, or the actions may be performed automatically.

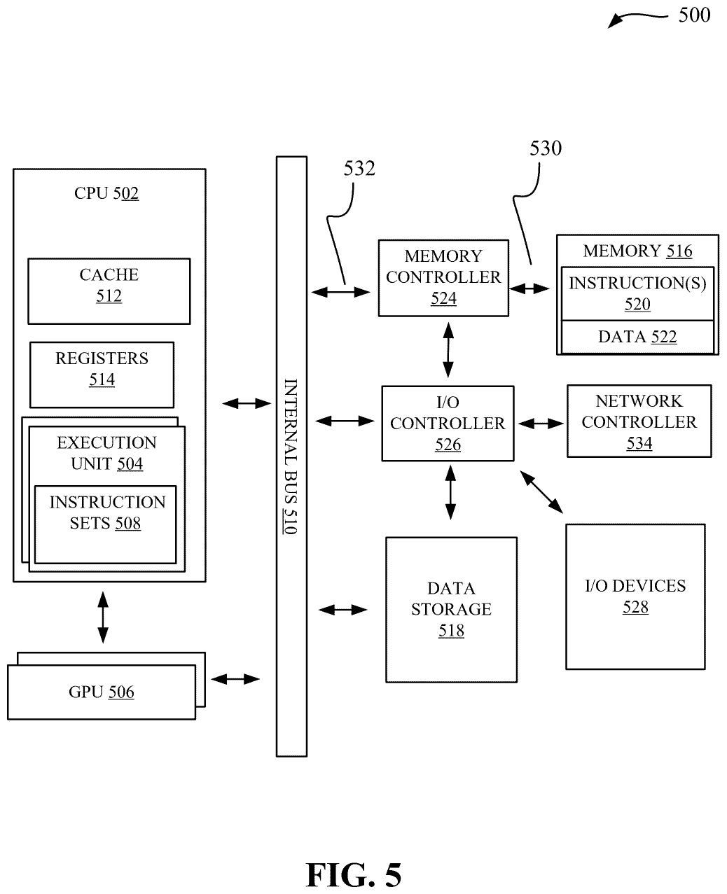

FIG. 5 illustrates a computing features 500 of an environment for a demand management system for material requirements planning, according to at least one embodiment. For example, the computing features 500 may be used to perform one or more aspects of the environment 100. Therefore, the computing features 500 can support an ODM to receive remand requests and supply, to reference build data, to analyze order lines and graphs, and to provide outputs including messages and reports. Further, the computing features 500 can support systems and software to manage demand described throughout herein. The computing features 500 may be connectable to any MRP system or may be connectable to receive an MRP system, such as a part of a ODM. For example, one or more of the computing features 500 may be individually connectable to part of a ODM. Further, the central processing unit (CPU) 502 may include one or more execution units 504 to perform any of the modules described herein.

The execution units 504 may include multiple circuits to support the ODM. The CPU 502 may be a special-purpose processor that is associated with one or more GPUs 506 to coordinate activities for managing demand of MRP systems. Therefore, one or more circuits of the computing features 500 are able to manage demand of MRP systems. Further, the one or more circuits of the computing features 500 is able to provide an API through which to receive ODM data. The one or more circuits of the computing features 500 can also provide the API, through which it is possible to receive the ODM data.

The computing features 500 may be performed by a system-on-a-chip (SOC), or some combination thereof, formed within a CPU 502. The CPU 502 may include execution units 504, as illustrated. The CPU 502 is able to execute instructions from one or more instruction sets 508. The CPU 502 includes support for logic in its execution units 504. The logic may be used to perform algorithms for processing. Further, the CPU 502 and the GPUs 506 include support for performing binary code. The one or more of the CPU 502 or the GPUs 506 can provide one or more action signals to drive demand for top-level components and sub-components.

In an example, an execution unit 504 may include logic to perform integer and floating point (FP) operations. The execution unit 504 may be within the one or more of the CPU 502 or the GPUs 506. However, there may be multiple execution units 504 that may be coordinated to perform distributed computing features of the managing described herein. Further, one or more of the CPU 502 or the GPUs 506 may include a microprocessor code from a read only memory (ROM) for performing macro-instructions. An execution unit 504 of one or more of the CPU 502 or the GPUs 506 may include logic to handle one or more different types of instruction sets 508.

The one or more different types of instruction sets 508 may include an instruction set of a special-purpose processor, along with associated circuits to execute instructions therefrom. Further, operations caused by the instructions may be used by the managing related modules described herein. There may be packed data in the one or more of the CPU 502 or the GPUs 506 which may be used with the instructions to provide the operations. The managing related modules herein, as in at least FIG. 1, may be subject to acceleration and may be executed efficiently using a full width of an internal bus 510.

The execution unit 504 may be provided via microcontrollers, embedded processors, or other components of the CPUs, GPUs, or DPUs. However, the execution unit 504 may be other types of logic circuits than provided in such CPUs, GPUs, or data processing units (DPUs). The computing features 500 may include a memory 516 that is external to the one or more of the CPU 502 or GPUs 506 but that is coupled to the one or more of the CPU 502 or GPUs 506 via a high speed internal bus 510. This memory 516 may be a Dynamic Random Access Memory (DRAM), a Static Random Access Memory (SRAM), a flash memory, or any other memory capable of working with the one or more of the CPU 502 or the GPUs 506 and with the high speed internal bus 510. The memory 516 is distinct from a further data storage 518 that may be used for long term storage. The memory 516 may include instruction(s) 520 and/or data 522. One or more of the instructions or data may be run or executed by the one or more of the CPU 502 or the GPUs 506. The memory may be accessible via a memory controller 524.

In one example, the CPUs 502 of the computing features 500 may include any of a PENTIUM® Processor family from Intel®, including Itanium®, XScale™ and/or StrongARM™; Intel's Core™, Nervana™, or Xeon™ based processors. However, other CPUs, such as AMD®'s Ryzen series, Intel's Core i series, Qualcomm®'s Snapdragon® series, and Samsung®'s Exynos series may also be used. In a further example, the computing features 500 may include GPUs 506, such as from NVIDIA®'s GeForce series or AMD®'s Radeon series.

Further, systems of computers may form part or all of the computing features 500 and may have other types of processors than listed above. These computers may be workstations, set-top boxes, or have similar computing capabilities as these devices and may also be used to perform aspects of the system and method of FIGS. 1-4 herein. The computing features 500 may run or execute aspects of an operating system, such as UNIX®, Linux®, or WINDOWS®, and can perform embedded software, as well as support different types of user interfaces, including graphical user interfaces (GUI).

The computing features 500 may be provided via fixed and mobile devices. These devices include personal computers, workstations, handheld devices, virtual devices, or datacenters. Some examples of mobile devices include laptops, cellular phones, smartphones, Internet Protocol (IP) devices, digital cameras, personal digital assistants (“PDAs”), and other handheld PCs. The computing features 500 may be performed on virtual devices that are supported by embedded applications. The embedded applications may include a microcontroller, a digital signal processor (DSP), an SOC, network computers, network hubs, switches, routers, gateways, or any other system that may perform one or more instructions described herein.

The computing features 500 may be supported by one or more of the CPU 502 or the GPUs 506 that may include a complex instruction set computer (CISC) microprocessor, a reduced instruction set computing (RISC) microprocessor, a very long instruction word (VLIW) microprocessor, a processor capable of combining instruction sets, or any other processor device. Further examples of a processor device include an application specific integrated circuit (ASIC), a DSP, or a DPU. As illustrated in FIG. 5, one or more of the CPU 502 or the GPUs 506 may be associated together and may be associated with other components using a high speed internal bus 510. The high speed bus 510 is capable of transmitting data and commands between the one or more of the CPU 502 or the GPUs 506 and between other components in the illustrated computing features 500.

The one or more of the CPU 502 or the GPUs 506 may include cache type memory. For example, one or more of the CPU 502 or the GPUs 506 may include a Level 1 (L1) internal cache memory (cache) 512. In a further example, the one or more of the CPU 502 or the GPUs 506 may include one or more internal cache. A multiple cache arrangement may be provided as a hierarchy or as levels of internal cache. As used herein, a cache is a type of memory that may reside internally or externally relative to each of the one or more of the CPU 502 or the GPUs 506. There is also possibility for a combination of an internal and external cache based in part on an application of the computing features 500. Further, the one or more of the CPU 502 or the GPUs 506 may include a registry or a register 514. The registry or register may be a file structure to retain different types of data. For example, there may be different types of the registry or registers. These may include integer registers, floating point (FP) registers, status registers, and an instruction pointer register.

A system logic chip capable of performing as the memory controller 524 may be provided between to a high speed internal bus 510 and the memory 516. The memory controller 524 and the one or more of the CPU 502 or the GPUs 506 may communicate via the high speed internal bus 510 using a high bandwidth memory path. This allows the one or more of the CPU 502 or the GPUs 506 to access the instruction(s) 520 and the data 522 for performing the testing described herein. The memory controller 524 may also be able to direct signals of data between one or more of the CPU 502 or the GPUs 506, the memory 516, and other components in the computing features 500.

In addition to the above, the memory controller 524 may also bridge signals of data between a high speed internal bus 510, a memory 516, and an input/output (I/O) controller 526. The memory controller 524 may include different types of ports, including ports for interfacing with one or more of the CPU 502 or the GPUs 506. At least one of the GPUs 506 may perform as a graphics controller for one of the input/output (I/O) device 528 which may include a display. The memory controller 524 may be associated with the memory 516 through a memory path 530 that is high bandwidth memory path. Although illustrated as coupled together via a high speed internal bus 510, the memory controller 524 may be coupled to one of the GPUs 506 via an Accelerated Graphics Port (AGP) interconnect 532. One or more of the CPU 502 may be coupled to one or more of the GPUs 506 directly or indirectly via a peripheral component interconnect express (PCIe®) interconnect standard. In addition, a network controller 534 may also be coupled to one or more of the CPU 502 or the GPUs 506 via a different interface that is also a PCIe interconnect standard. Further, some or all of the interconnected devices or chips herein may be provided via SOC. Therefore, some or all of the interconnected devices of FIG. 5 may be interconnected with proprietary interconnects. However, some or all of the interconnected devices of FIG. 5 may be interconnected by a combination of standardized interconnects (such as, PCIe and compute express link or CXL®) and the proprietary interconnects.

The computing features 500 herein may use the I/O controller 526 as a proprietary interface to bring together the memory controller 524, the network controller 534, and one or more of the other I/O devices 528. One or more of the controllers herein may include direct connections to some I/O devices 528 via a local I/O bus that may include a high-speed I/O bus for connecting peripherals to a memory 516, a chipset, and to one or more of the CPU 502 or the GPUs 506. The I/O devices 528 may include an audio controller, a firmware hub (such as a, a basic input/output system or BIOS), a transceiver, the data storage 518, a display, and any I/O controllers. The I/O controllers 526 may include input devices, including a keyboard interface, a mouse interface, a touch interface, a gesture interface, and one or more expansion ports, including a Universal Serial Bus (USB) port. The data storage 518 may include a flash memory storage, a hard disk drive, or any removable non-transitory storage media having instructions thereon. For example, a CD-ROM device, a flash memory device, or other mass storage device.

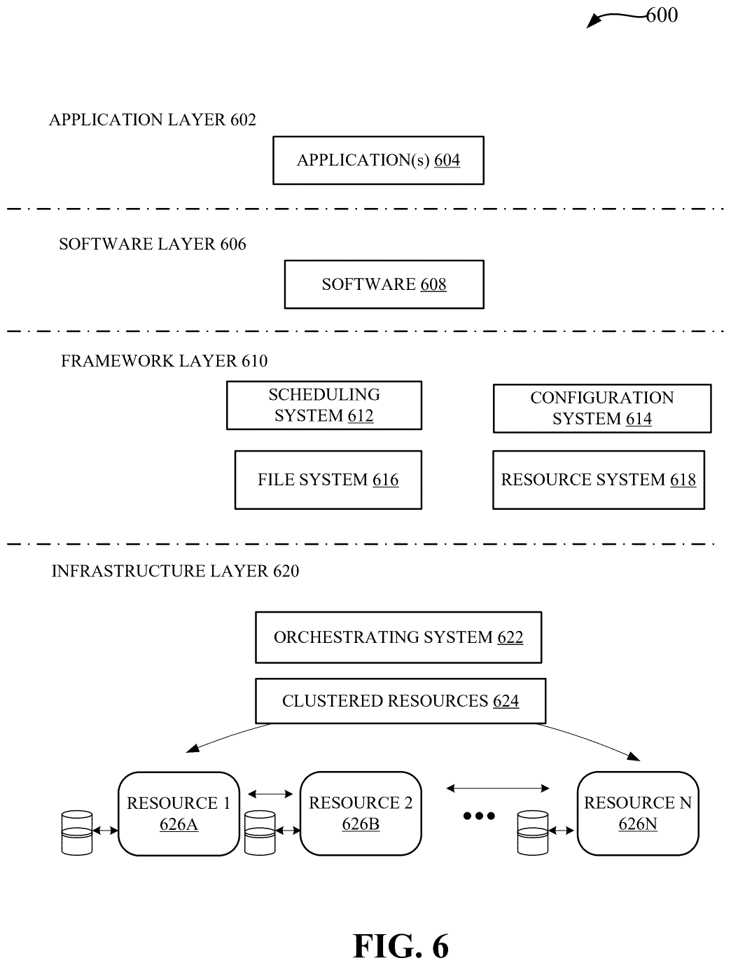

FIG. 6 illustrates further computing features 600 of an environment for a demand management system for material requirements planning, according to at least one embodiment. Like in the case of FIG. 5, the further computing features 600 herein may be used to perform one or more aspects of the environment 200. Therefore, the further computing features 600 may be connectable to a MRP. For example, the further computing features 600 may be individually connected to part of a MRP, such as a ODM. Differently than FIG. 5, one or more parts of the further computing features 600 may be provided remotely, such as, by a data center or other virtual environment performing over physical resources. This enables managing demand to be partly performed in a cloud environment, for instance.

In one example, a data center may include one or more of the further computing features 600 of FIG. 6. The further computing features 600 may include an application layer 602, a software layer 606, a framework layer 610, and an infrastructure layer 620. One or more of such layers may be enabled by a physical or logical separation. The logical separation may be provided by secure environments of the data center and may be supported by networking devices, including gateways, routers, and switches. The physical separation may be enabled by one or more of the illustrated resources 626A-626N being at different physical locations and supported by the networking devices.

In one example, the application layer 602 may include one or more application(s) 604 that may be associated with API(s) to perform managing demand described throughout herein. Within the application layer 602, one or more types of applications may be used by an ODM. Further, the applications may be performed using one or more portions of the illustrated individual resources 626A-626N, the clustered resources 624, and/or the orchestrating system 622 of the infrastructure layer 620. The application layer 602 may be user-facing.

The software layer 606 may include one or more different software 608 or portions thereof, that are also performed using one or more portions of the illustrated individual resources 626A-626N, the clustered resources 624, and/or the orchestrating system 622 of the infrastructure layer 620. However, the one or more different software 608 may be an operating system or a shell that may be deployed or that use on one or more of the resources or the file system described herein. Therefore, an application 604 of an application layer 602 may be performed within the software layer 606 or may use a software of the software layer 606. The software 608 may additionally include drivers, search software, scan software, database software, and other content software to perform an application.

The framework layer 610 may include one or more frameworks that support the software 608 of a software layer 606. The framework layer 610 may also include at least one framework that supports application(s) 604 of the application layer 602. As such, there may be a single framework or multiple frameworks to support one or more of the software 608 or the application(s) 604. The software 608 or the application(s) 604 may include web service software or web service applications. A web service software or application may be as provided by Google®'s Cloud®, Microsoft®'s Azure®, or Amazon® Web Services. The framework layer 610 may include web service frameworks, including Apache Spark®. A file system 616 of a framework having Apache Spark® may utilize a file system 616 that may be a distributed file system adapted for large data processing. Further, the framework layer 610 may include a configuration system 614 and a resource system 618.

The framework layer 610 may include a scheduling system 612, a configuration system 614, and a resource system 618, in addition to the file system 616. The scheduling system 612 may include drivers that may be used to schedule deployment of a workload, such as for demand management. The workload may also be performed using the resources 626A-626N and may be also supported by other layers of the further computing features 600 herein. A configuration system 614 may be provided for configuring the different layers herein. A resource system 618 may be provided for controlling a clustering or grouping of the individual resources 626A-626N or of the clustered resources 624, which may be mapped to or allocated in support of a file system 616. A scheduling system 612 may be used to support scheduling of the workloads with the individual resources 626A-626N or with the clustered resources 624. The resource system 618 may work with an orchestrating system 622 of the infrastructure layer 620 to control the mapping mapped or allocated resources.

An infrastructure layer 620 herein may include the orchestrating system 622, the clustered resources 624, and the individual resources 626A-626N. The individual resources 626A-626N may include CPUs, GPUs, DPUs, or other processors adapted for performing the environments in FIG. 2, for instance. The other processors may be field programmable gate arrays (FPGAs) and process accelerators. The individual resources 626A-626N may include memory devices (such as, dynamic ROM and RAM), storage devices (such as, solid state, optical, or magnetic storage), network devices (such as gateways, routers, and switches), and virtual machines (VMs). However, it is also possible to include power modules and cooling modules as part of the individual resources 626A-626N.

Further, the clustered resources 624 may be two or more of such individual resources 626A-626N. A cluster resource may include a complete server having processing, memory, communication, power, and cooling resources working together to perform a workload. In addition, an orchestrating system 622 may be able to perform self-controlling actions based at least in part on data or data types associated with the workload. The self-controlling actions may be to avoid underutilization of resources or may be to change resources having less than optimal performance of a workload, for instance.

The clustered resources 624 herein may include separate groupings of the individual resources 626A-626N. The individual resources 626A-626N may be physically provided within one or more racks or server trays that may be part of a data center having the further computing features 600 herein. As such, one or more of the illustrated further computing features 600 may be located in physically distinct locations. Separate groupings of individual resources 626A-626N, provided within clustered resources 624, can enable computing, networking, and storage and other parts of the individual resources 626A-626N to be used to support one or more workloads. For example, aspects of the individual resources 626A-626N may be configured or allocated to a clustered resources 624 that performs a workload. The individual resources 626A-626N may include CPUs, GPUs, DPUs, or other processors which may be clustered within one or more or server trays as part of the clustered resources 624 herein. The racks or server trays may be additionally associated with one or more of power modules, cooling modules, or network switches from the infrastructure layer 620.

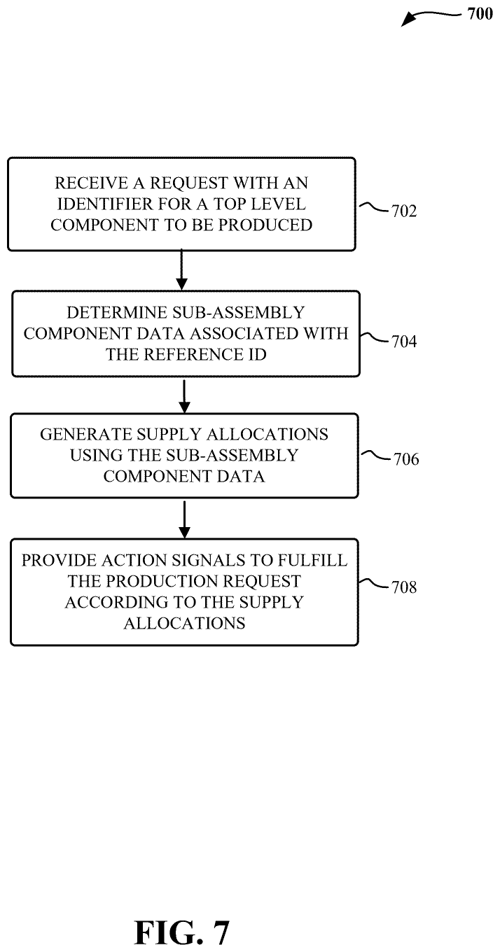

FIG. 7 illustrates a process flow or method 700 for a demand management system for material requirements planning, according to at least one embodiment. It should be understood that for this and other processes presented herein that there may be additional, fewer, or alternative operations performed in similar or alternative orders, or at least partially in parallel, within the scope of the various embodiments unless otherwise specifically stated. The method 700 includes a request with a component identifier may be received 702, where the component identifier may identify a top-level module component to be produced according to the request. The component identifier may be requested within a large scale, complex organization or system, where myriad of components are able to be produced, built, or manufactured. The request may be received to an automated MRP system, and the request may be received with additional information, such a deadline date or an indication of a production template to be followed. The request may be received as part of a multi-level process or system, such as rocket and/or aerospace-industry related group, with a large-scale and/or long-term considerations. The top-level module component may have a level of complexity which requires multiple parts, processing, assessments, or other actions to fulfil the request, such as a rocket engine. Data associated with the identifier may be determined 704. The data may be determined based on the component identifier for the top-level module component. The data may include one or more additional component identifiers for the sub-components. The data may be stored in one or more templates that can be referenced based on the component identifier for the top-level module component.

Further, the method 700 includes supply allocations which may be generated 706 based on the data associated with the component identifier. The supply allocations may be generated from instructions for completing the request. The instructions may provide line items that include details associated with the top-level module component and the sub-components. The supply allocation may be completed by matching the demand for the components with the supply of the components based on one or more factors, such as a requested deadline and whether a component can be built or bought. One or more action signals may be provided 708 to fulfill the production request for the top-level module component according to the supply allocations. The action signal may include recommendations or directions for procuring supply for the sub-components and the top-level module components. The action signals may be provided to recipients or groups, as part of a larger entity, which coordinate to fulfil the productions request. The action signals may also be automatically completed to fulfill the production request.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Use of terms “a” and “an” and “the” and similar referents in context of describing embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

1. A system comprising:
at least one processor and memory comprising instructions which when executed by the at least one processor cause the system to:
receive a production request comprising a component identifier for a top-level module component to be produced, the component identifier corresponding to the top-level module component from a plurality of components;
determine, using the component identifier, data associated with the top-level module component from a source other than the production request, the data at least identifying sub-components to be consumed to produce the top-level module component;
automatically generate, based at least in part on the data, supply allocations for the top-level module component and the sub-components, the supply allocations bein automatically updated as the production request is fulfilled; and
transmit one or more action signals to one or more recipient devices when coordinated according to the supply allocations, the one or more action signals being configured to fulfill the production request.

2. The system of claim 1, wherein the instructions which when executed by the at least one processor further cause the system to:
determine, using the component identifier, one or more production templates comprising at least one line item; and
cause the at least one line item to be cascaded.

3. The system of claim 1, wherein the instructions which when executed by the at least one processor further cause the system to:
calculate, based on durations associated with producing the top-level module component and the sub-components, a total duration for fulfilling the request; and
use the total duration to generate the supply allocations.

4. The system of claim 1, wherein the instructions which when executed by the at least one processor further cause the system to:
generate a demand graph, based at least in part on the data associated with the top-level module component, to generate the supply allocations.

5. The system of claim 4, wherein the demand graph comprises a plurality of nodes associated with the top-level module component and the sub-components and further comprises a plurality of connections between the nodes which indicate an order to complete the nodes.

6. The system of claim 1, wherein the instructions which when executed by the at least one processor further cause the system to:
determine, based on the component identifier, one or more guidelines to fulfill the request, the one or more guidelines being associated with a respective one of the top-level module component and the sub-components.

7. The system of claim 6, wherein the instructions which when executed by the at least one processor further cause the system to:
cause a status of one or more of the guidelines to be indicated as complete based on the respective one of the top-level module component and the sub-components being supplied; and
update the supply allocations based on the status being indicated as complete.

8. The system of claim 1, wherein one or more of the supply allocations are configured to be based at least in part on a completion deadline provided with the production request.

9. The system of claim 1, wherein one or more of the action signals comprise a recommendation to obtain at least one of the sub-components.

10. One or more circuits to:
transmit one or more action signals to one or more recipient devices when coordinated according to supply allocations for a top-level component and one or more sub-components to fulfill a request, the supply allocations being automatically generated based on the sub-components determined from a source other than the request using an identifier corresponding to the top-level component from a plurality of components, wherein the supply allocations are automatically updated as the request is fulfilled.

11. The one or more circuits of claim 10, wherein the one or more circuits is further to determine, based on the identifier, one or more guidelines to fulfill the top-level component, the one or more guidelines being associated with a respective one of the top-level component and the sub-components.

12. The one or more circuits of claim 11, wherein the one or more circuits is further to cause a status of one or more of the guidelines to be indicated as complete based on the respective one of the top-level component and the sub-components being supplied.

13. The one or more circuits of claim 12, wherein the one or more circuits is further to update the supply allocations based on status being indicated as complete.

14. The one or more circuits of claim 10, wherein the one or more action signals comprise a recommendation to obtain at least one of the sub-components.

15. A computer-implemented method, comprising:
receiving a request comprising an identifier for a top-level component, the identifier corresponding to the top-level component from a plurality of components;
determining, using the identifier, data associated with the top-level component from a source other than the request, the data at least identifying sub-components to be consumed to fulfill the request;
automatically generating, based at least in part on the data, supply allocations for the top-level component and the sub-components, the supply allocations being automatically updated as the request is fulfilled; and
transmitting one or more action signals to one or more recipient devices when coordinated according to the supply allocations, the one or more action signals being configured to fulfill the request.

16. The method of claim 15, further comprising:
determining, using the identifier, one or more templates comprising at least one line item; and
causing the at least one line item to be cascaded.

17. The method of claim 15, further comprising:
generating a demand graph, based at least in part on the data associated with the top-level component, to generate the supply allocations.

18. The method of claim 17, wherein the demand graph comprises a plurality of nodes associated with the top-level component and the sub-components and further comprises a plurality of connections between the nodes which indicate an order to complete the nodes.

19. The method of claim 15, wherein one or more of the supply allocations are configured to be based at least in part on a completion deadline provided with the request.

20. The method of claim 15, wherein one or more of the action signals include a recommendation to obtain at least one of the sub-components.
